(19) United States
(12) Patent Application Publication
(10) Pub. No.: US 2021/0059339 A1
(43) Pub. Date: Mar. 4, 2021

(54) ARTIFICIAL EYELASHES FOR EXTENSION

(71) Applicant: QuadU CO., LTD., Ulsan (KR)

(72) Inventor: Myun-Woo LEE, Yongin-si (KR)

(73) Assignee: QuadU CO., LTD., Ulsan (KR)

(21) Appl. No.: 16/862,820

(22) Filed: Apr. 30, 2020

(30) Foreign Application Priority Data
Sep. 4, 2019 (KR) 10-2019-0109457

(51) Int. Cl. A41G 5/02

(52) U.S. Cl. CPC A41G 5/02

(57) ABSTRACT

Disclosed are artificial eyelashes for extension which are configured to significantly improve working efficiency and to perform high-quality treatment by omitting a complicated process of applying an adhesive to eyelashes of a person to be treated and simply attaching the artificial eyelashes during eyelash extension procedure. The artificial eyelashes include a bonding member provided on a point spaced apart from in a vicinity of root portions of eyelash strands, configured to be a solid member attached to the eyelash strands at room temperature, and melted with viscosity to bond the eyelash strands to the eyelashes of the person to be treated when heat at a certain temperature or higher is applied.

### CROSS-REFERENCE TO RELATED APPLICATION

This application claims priority to Korean Patent Application No. 10-2019-0109457 (filed on Sep. 4, 2019), which is incorporated herein by reference in its entirety.

### BACKGROUND

The present invention relates to artificial eyelashes for extension, and more particularly, to artificial eyelashes for extension, in which the artificial eyelashes may be simply attached and a difficult process of applying adhesives to eyelashes of a person to be treated during an eyelash extension procedure may be omitted so as to significantly improve working efficiency and to perform high-quality treatment.

Generally, in a cosmetic aspect, eyelashes are very significant. Particularly, women generally prefer long and curled upward eyelashes the most and form such eyelashes using mascara.

The mascara corresponds to the simplest method of performing a function of first properly forming a shape of eyelashes and applying black color to the made-up eyelashes and is in general use. A method of using mascara is basically applied to long eyelashes so that more aesthetic eyelashes may be made.

However, in the case of short eyelashes, aesthetics have been improved using a method of extending eyelashes by attaching additional artificial eyelashes. Artificial eyelashes include an eyelash portion including a plurality of eyelash strands and a base portion configured to tie up and support the eyelash strands. Here, the artificial eyelashes are attached to real eyelashes on an eyelid by applying an adhesive to the base portion.

Since it is necessary for a user to directly and precisely attach the artificial eyelashes to the eyelid, when the user is not skilled, there is a disadvantage that a large amount of time is consumed in attachment which is very inconvenient.

To overcome the above disadvantage, an attachment tool capable of easily attaching eyelashes has been disclosed in Korean Utility Model Registration No. 165452. However, since the above artificial eyelashes provide excellent makeup but are used as a disposable product, there is a disadvantage of attaching new artificial eyelashes whenever necessary. Also, there is a disadvantage of carrying artificial eyelashes outdoors.

Meanwhile, in the case of short eyelashes, in addition to the artificial eyelashes, an eyelash extension method is present. The eyelash extension method is generally performed in skin care shops or hair salons and has an advantage of forming long eyelashes by attaching extending eyelashes using an adhesive and has an advantage of maintaining a treated state for several months after treatment. Related thereto, some related arts have been disclosed.

For example, Korean Patent Publication No. 10-2005-0094973 (Sep. 29, 2005) discloses a method of having eyelashes permed. The above method includes attaching extending eyelashes and setting an entirety of eyelashes and has an advantage of reducing a time of applying makeup to eyelashes by simply using mascara to make eyelashes black after perm and has an advantage of maintaining a treated shape for a relatively long time after one time treatment.

However, in the case of the above extension method, since all operations are manually performed one by one, a large amount of time is necessary and high-level of skill is needed. Particularly, since a process of attaching artificial eyelashes to real eyelashes using an adhesive is a complicated operation that should be most delicately performed, the process cannot be performed at once and it is necessary to perform the process in parts over several procedures. Additionally, according to the above related art, there is a crucial problem that a risk of nearly damaging an eyeball of a person to be treated is high.

### SUMMARY

The present invention is directed to providing artificial eyelashes for extension capable of significantly improving working efficiency and performing high-quality treatment by omitting a complicated process of applying an adhesive to eyelashes of a person to be treated and simply attaching the artificial eyelashes during an eyelash extension procedure.

According to an aspect of the present invention, there is provided artificial eyelashes for extension, which are configured to be attached to eyelashes of a person to be treated to extend a length of the eyelashes. The artificial eyelashes include a bonding member provided on a point spaced apart from a vicinity of root portions of eyelash strands, configured to be a solid member attached to the eyelash strands at room temperature, and melted with viscosity to bond the eyelash strands to the eyelashes of the person to be treated when heat at a certain temperature or higher is applied.

The bonding member may be a linear member provided to be parallel, with a gap therebetween, to a base configured to connect the root portions of the eyelash strands. The bonding member may be attached to a front or a rear of the eyelash strands while protruding therefrom. The bonding member may be provided to have a length which exceeds a region in which the eyelash strands are arranged such that ends thereof may protrude leftward and rightward. The bonding member is configured to be melted at a temperature of 90° C. to 130° C.

The bonding member may include ethylene-vinyl acetate (EVA) copolymer as a major material having the highest content. A pigment for imparting color may be further added, as an additive, to the bonding member. The vitamin A, vitamin C, vitamin E, and peptides may be added to the bonding member to be absorbed into the eyelashes of the person to be treated when the bonding member is heated and melted.

To correspond to an exclusive shield for the artificial eyelashes, which is divided into an upper body and a lower body so that front ends thereof form one pair and are opened or closed to clasp the eyelashes of the person to be treated while an extension operation of adding the artificial eyelashes to the eyelashes of the person to be treated to extend a length thereof and which includes an accommodation groove having a concave curve to accommodate a protruding eyeball of the person to be treated with an eye being closed in a front of the front end while facing the eyeball and being in contact with an eyelid of the person to be treated and includes a safety cover behind the accommodation groove and having a working space with a rearward-opening inlet to accommodate the eyelashes of the person to be treated which are clasped between the front end of the upper body and the front end of the lower body and protrude, the bonding member may be spaced at a distance of 1.0 to 5.0 mm apart from the root portions of the eyelash strands to be located in the working space provided in the safety cover of the shield when the front end of the upper body and the front end of the lower body of the shield clasp the eyelashes of the person to be treated and the root portions of the eyelash strands together. The accommodation groove of the shield may be formed to have a depth of 13.15 to 15.36 mm, a lateral width of 32.44 to 36.05 mm, and a longitudinal length 32.59 to 36.21 mm, and the bonding member may be formed to have a lateral width less than the lateral width of the accommodation groove so as to be accommodated in the working space of the safety cover through the accommodation groove of the shield.

The front of the front end where the accommodation groove of the shield is formed may have a curvature radius of 21 to 22 mm, and the bonding member may be formed as a curve corresponding to the curvature radius of the accommodation groove of the shield.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a perspective view of artificial eyelashes for extension according to one embodiment of the present invention;

FIG. 2 is a front view of the artificial eyelashes for extension according to one embodiment of the present invention;

FIG. 3 is a cross-sectional view illustrating a bonding member of the artificial eyelashes for extension according to one embodiment of the present invention;

FIGS. 4A to 4D are reference views illustrating a series of processes of bonding the artificial eyelashes for extension according to one embodiment of the present invention to eyelashes of a person to be treated;

FIG. 5 is a perspective view of an exclusive eyelash extension system for the artificial eyelashes for extension according to one embodiment of the present invention;

FIG. 6 is a partial exploded view of the exclusive eyelash extension system for the artificial eyelashes for extension according to one embodiment of the present invention;

FIG. 7 is a perspective view illustrating components of a shield of the exclusive eyelash extension system for the artificial eyelashes for extension according to one embodiment of the present invention;

FIG. 8 is a plane view of the shield of the exclusive eyelash extension system for the artificial eyelashes for extension according to one embodiment of the present invention;

FIG. 9 is a side view of the shield of the exclusive eyelash extension system for the artificial eyelashes for extension according to one embodiment of the present invention;

FIG. 10 is a side cross-sectional view of the shield of the exclusive eyelash extension system for the artificial eyelashes for extension according to one embodiment of the present invention;

FIG. 11 is a reference view illustrating effects and operations of the shield of the exclusive eyelash extension system for the artificial eyelashes for extension according to one embodiment of the present invention; and

FIG. 12 is a reference view illustrating design numerals of a safety cover accommodation portion of the shield in the exclusive eyelash extension system for the artificial eyelashes for extension according to one embodiment of the present invention.

### DETAILED DESCRIPTION

Artificial eyelashes for extension according to embodiments of the present invention will be described in detail with reference to the attached drawings. Since the present invention may be variously modified and have a variety of forms, particular embodiments will be illustrated in the drawings and described in detail in the text. However, these are not intended to limit the present invention to a particularly disclosed form and it should be understood that the present invention includes all changes, equivalents, and substitutes included within the concept and technical scope of the present invention. In a description on each drawing, like elements will be referred to as like reference numerals. In the attached drawings, sizes of structures may be exaggerated for clarity of the present invention or reduced for understanding a schematic configuration.

Also, the terms such as first, second, and the like may be used to describe a variety of components, and the components are not limited to the terms. The terms are used only for distinguishing one component from another. For example, without departing from the scope of the present invention, a first component may be referred to as a second component, and similarly, the second component may be referred to as the first component. Meanwhile, unless otherwise defined, all terms used herein including technical or scientific terms have the same meanings as those generally understood by one of ordinary skill in the art. The terms as defined in generally used dictionaries should be understood as having meanings which coincide with contextual meanings of related art and will not be understood as having ideal or excessively formal meanings unless clearly defined in the present application.

### Embodiment

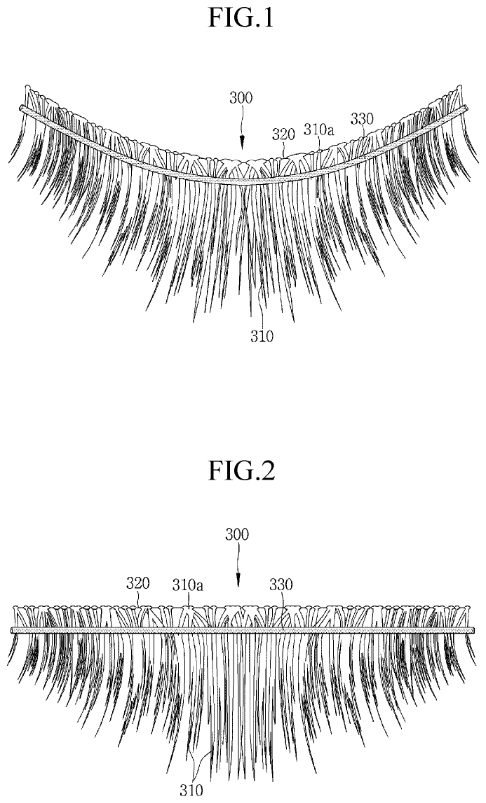

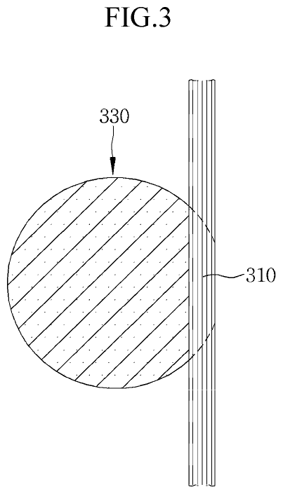

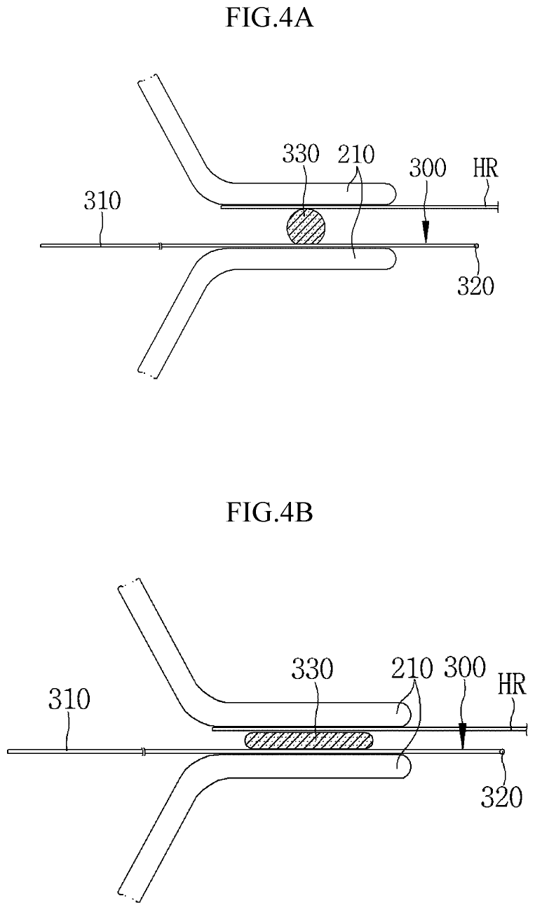

FIG. 1 is a perspective view of artificial eyelashes for extension according to one embodiment of the present invention, FIG. 2 is a front view of the artificial eyelashes for extension according to one embodiment of the present invention, and FIG. 3 is a cross-sectional view illustrating a bonding member of the artificial eyelashes for extension according to one embodiment of the present invention.

As shown in the drawings, artificial lashes 300 for extension according to one embodiment of the present invention are configured to be added to eyelashes of a person to be treated so as to extend a length thereof and include a plurality of eyelash strands 310, a base 320 configured to connect root portions 310a of the eyelash strands 310 in a row, and a bonding member 330.

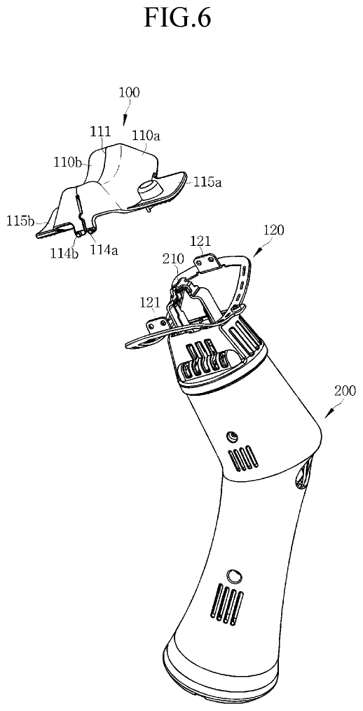

The bonding member 330 is a linear member provided to be parallel with a space from the base 320 which connects the root portions 310a of the eyelash strands 310. The bonding member 330 is provided as a solid member at a room temperature while being attached to the eyelash strands 310, is melted when heat at a temperature within a range of 90° C. to 130° C., and more particularly, about 110° C., is applied and solidified again so as to have high bonding property. To this end, when the bonding member 330 is heated using grips 210 of a thermal bonding device 200 shown in FIG. 6 while the eyelashes of the person to be treated are overlapped with the eyelash strands 310, the eyelashes of the person to be treated may be simply bonded to the eyelash strands 310 without a complicated process of applying an additional adhesive.

Here, the bonding member 330 includes ethylene-vinyl acetate (EVA) copolymer as a major material having the highest content. Due to high bonding property at a high level melted state and excellent pliability, shock resistance, stress resistance, and cracking property, EVA is very appropriate for a material of the bonding member 330. The bonding member 330 formed of the above EVA material performs a function as an adhesive when being heated and melted and performs a function of holding and supporting the eyelash strands 310 with the root portions 310a connected in a row by the base 320 in an aligned state to more stably maintain the aligned state before being melted. In addition, the bonding member 330 may be formed to be a natural curve fitting in with eyelashes instead of a straight line so as to support the eyelash strands 310. While elasticity is provided by the above EVA material, even when an external force or a shock is applied, an original form is immediately restored and it is possible to continuously maintain the aligned state of the eyelash strands 310. Here, in order to compensate for a function of elasticity and the like which may be insufficient with EVA alone, a small amount of some additives may be added.

Also, a small amount of pigment for imparting color is added to the bonding member 330 as an additive. Since the bonding member 330 may have any colors which are equal or similar to a color of the eyelash strands 310 so as to be naturally harmonized with the eyelash strands 310 of the artificial eyelashes 300 and the eyelashes of the person to be treated while being melted and flowing thereinto, eco-friendly pigments or cosmetic pigments which have no harm to the skin or eyes may be used. In addition, vitamin A, vitamin C, vitamin E, and peptides are added to the bonding member so as to be absorbed by the eyelashes of the person to be treated when the bonding member is heated and melted. According to the above bonding member to which vitamin A, vitamin C, vitamin E, and peptides are added, the eyelashes of the person to be treated which are partially damaged while receiving high-temperature heat due to the eyelash extension procedure are helped in reproducing at a high speed.

Observing a shape of the bonding member 330 closely, as shown in a cross-sectional view of FIG. 3, the bonding member 330 is attached to a front of the eyelash strands 310 while protruding and both ends thereof have a length which exceeds a region, in which the eyelash strands 310 are arranged as shown in an enlarging portion of FIG. 2, and slightly protrude leftward and rightward. To attach the bonding member 330 to the front of the eyelash strands 310 as described above, during a process of manufacturing the artificial eyelashes 300 for extension, a semi-product in which the eyelash strands 310 are aligned while being supported by the base 320 is manufactured first, the bonding member 330 molded through extrusion is placed on the front of the eyelash strands 310 disposed on a plate, and a pressure is applied to the eyelash strands 310 before the bonding member 330 is completely solidified. Then, the bonding member 330 is attached to the front of the eyelash strands 310 while protruding therefrom and barely protrudes from a rear of the eyelash strands 310. However, the bonding member 330 may be attached while protruding from the rear of the eyelash strands 310 instead of the front, which may be selectively implemented to provide a variety of types of products.

According to the bonding member 330 attached to the front of the eyelash strands 310 instead of the rear while protruding therefrom, when the eyelash strands 310 are overlapped with the eyelashes of the person to be treated to be bonded thereto, it is possible to secure an adequate amount of adhesive while the bonding member 330 is melted without being interrupted by the bonding member 330.

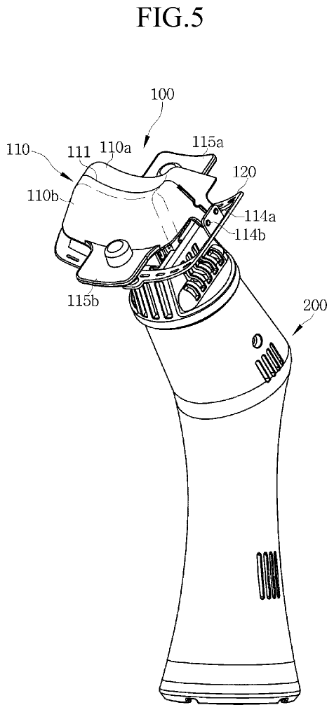

One of very significant aspects of the artificial eyelashes 300 for extension according to one embodiment of the present invention is a shape corresponding to an exclusive shield 100 (refer to FIGS. 5 to 11) for the artificial eyelashes 300 for extension which will be described below. That is, when a front end of an upper body 110a and a front end of a lower body 110b of the shield 100 clasp the eyelashes of the person to be treated and the root portions 310a of the eyelash strands 310 together, the bonding member 330 is spaced at a distance of 1.0 to 5.0 mm apart from the root portions 310a of the eyelash strands 310 to be located in a working space provided in a safety cover 110 of the shield 100. Also, an accommodation groove 111 of the shield 100 has a depth of 13.15 to 15.36 mm, a lateral width of 32.44 to 36.05 mm, and a longitudinal length 32.59 to 36.21 mm. Here, corresponding thereto, the bonding member 330 has a lateral width less than the lateral width of the accommodation groove 111 to be accommodated in the working space of the safety cover 110 through the accommodation groove 111 of the shield 100. Accordingly, it is necessary to form the lateral width of the bonding member 330 to be smaller than or equal to 36.05 mm. Meanwhile, a curvature radius of a front of the front end where the accommodation groove 111 of the shield 100 is formed is 21 to 22 mm. Here, the bonding member 330 may be formed to be a curve having a curvature radius equal or similar to the curvature radius of the accommodation groove 111 of the shield 100 to correspond thereto.

As described above, the artificial eyelashes 300 for extension according to one embodiment of the present invention significantly enhance working efficiency in treatment of extending eyelashes and perform high-quality treatment using the exclusive shield 100 which will be described below in detail with reference to FIGS. 5 to 11.

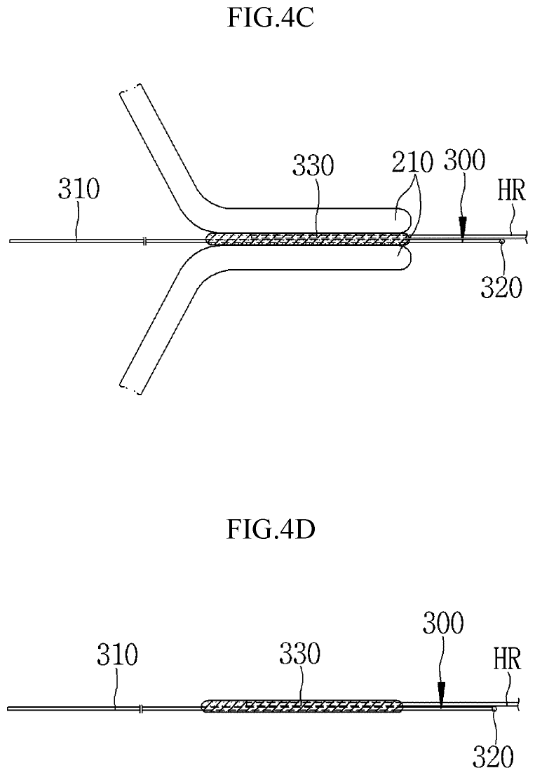

FIGS. 4A to 4D illustrate a series of processes of bonding the above-described artificial eyelashes 300 for extension according to one embodiment of the present invention to the eyelashes of the person to be treated using the thermal bonding device 200. The series of processes will be described below in detail.

First, as shown in FIG. 4A, the root portions 310a of the eyelash strands 310 are overlapped with and temporarily adhered to eyelashes HR of a person to be treated with the bonding member 330 therebetween. Then, the bonding member 330 is naturally located in a region in which the eyelashes HR of the person to be treated are overlapped with the eyelash strands 310. However, temporary adhesion between the eyelashes HR of the person to be treated and the eyelash strands 310 may be adequately performed using any adhesives which have some viscosity instead of strong adhesion performance and which are harmless to a human body.

Subsequently, when the thermal bonding device 200 is operated by pushing a switch thereof while a pair of grips 210 of the thermal bonding device 200, which is heated at a high temperature, are located on both sides of the bonding member 330, as shown in FIGS. 4B and 4C, the pair of grips 210 heat and pressurize the bonding member 330 on both sides. Also, between the pair of grips 210 which are heated at a high temperature, the bonding member 330 is melted and compressed at the same time to meticulously permeate gaps in the region in which the eyelashes HR of the person to be treated are overlapped with the eyelash strands 310 so as to bond the eyelashes HR of the person to be treated to the eyelash strands 310.

Subsequently, when the grips 210 of the thermal bonding device 200 are removed, the liquid-type bonding member 330 which has permeated into the gaps between the eyelash strands 310 and the eyelashes HR of the person to be treated with viscosity while being melted is solidified again at room temperature so as to very stably bond the eyelash strands 310 to the eyelashes HR of the person to be treated as shown in FIG. 4D.

Subsequently, an eyelash extension system including the exclusive shield for the artificial eyelashes for extension and the thermal bonding device according to one embodiment will be described below.

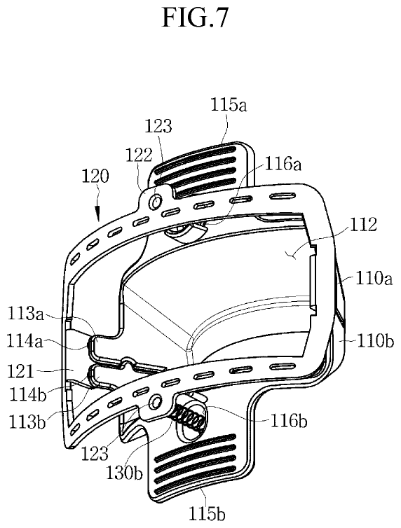

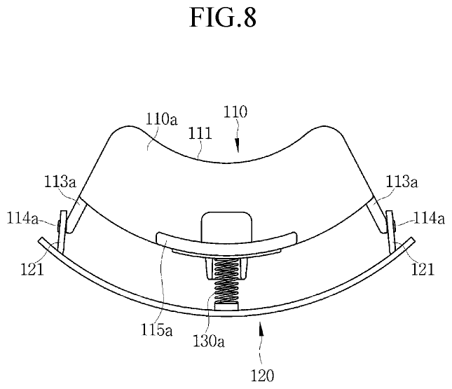

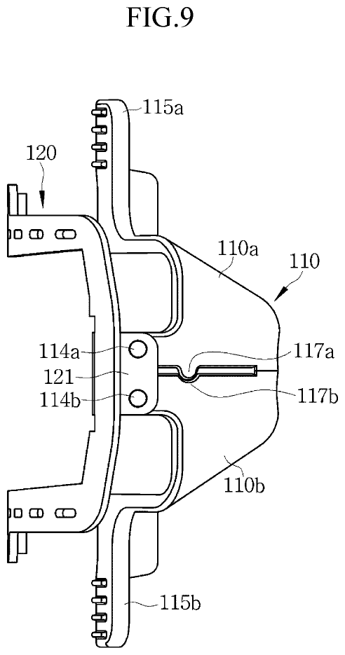

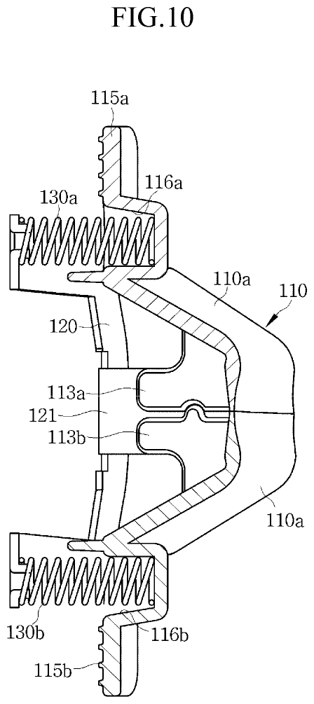

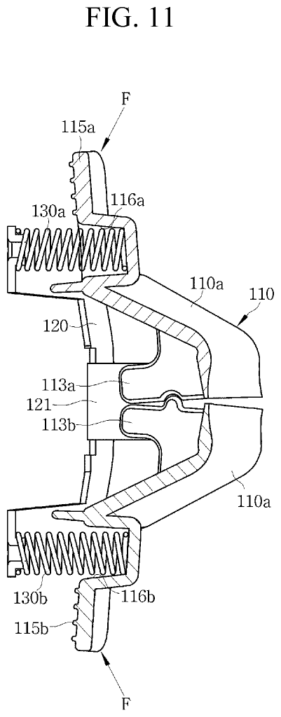

FIG. 5 is a perspective view of an exclusive eyelash extension system for the artificial eyelashes for extension according to one embodiment of the present invention. FIG. 6 is a partial exploded view of the exclusive eyelash extension system for the artificial eyelashes for extension according to one embodiment of the present invention. FIG. 7 is a perspective view illustrating components of a shield of the exclusive eyelash extension system for the artificial eyelashes for extension according to one embodiment of the present invention. FIG. 8 is a plane view of the shield of the exclusive eyelash extension system for the artificial eyelashes for extension according to one embodiment of the present invention. FIG. 9 is a side view of the shield of the exclusive eyelash extension system for the artificial eyelashes for extension according to one embodiment of the present invention. FIG. 10 is a side cross-sectional view of the shield of the exclusive eyelash extension system for the artificial eyelashes for extension according to one embodiment of the present invention. FIG. 11 is a reference view illustrating effects and operations of the shield of the exclusive eyelash extension system for the artificial eyelashes for extension according to one embodiment of the present invention.

As shown in the drawings, the exclusive eyelash extension system for artificial eyelashes for extension according to one embodiment of the present invention includes the shield 100 and the thermal bonding device 200 to perform a series of operations of extending eyelashes of a person to be treated by bonding the artificial eyelashes 300 thereto.

It should be noted that it is possible to comfortably and safely protect an eyeball with the shield 100 ergonomically designed in consideration of a protruding level of the eyeball and a lateral width and a longitudinal length of an eye socket of the person to be treated and to significantly improve working efficiency by simplifying an eyelash extension operation.

Hereinafter, the exclusive eyelash extension system for artificial eyelashes for extension according to one embodiment of the present invention will be described in detail around the shield 100.

As shown in FIGS. 5 to 11, the shield 100 is configured to safely protect the eyeball of the person to be treated and to aid in efficiently performing an operation of extending the eyelashes by clasping the eyelashes and includes the safety cover 110, a support frame 120, and springs 130a and 130b.

The safety cover 110 is formed as a container-shaped body having an open rear side. The body is configured to be divided into the upper body 110a and the lower body 110b and front ends thereof form a pair to be opened or closed so as to clasp the eyelashes of the person to be treated.

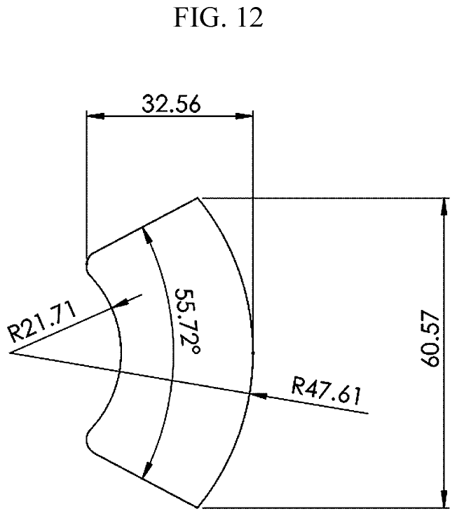

The safety cover 110 includes the accommodation groove 111 in a front of the front end, which is formed as a concave curve to accommodate a protruding eyeball of the person to be treated with an eye being closed while facing and being in contact with the eyelid. The above accommodation groove 111 is ergonomically designed, on the basis of verified materials, in consideration of protruding levels of eyeballs and lateral widths and longitudinal lengths of eye sockets of Asians or Westerners to have a depth of 13.15 to 15.36 mm, a lateral width of 32.44 to 36.05 mm, and a longitudinal length of 32.59 to 36.21 mm. Also, as shown in FIG. 12, a curvature radius R of the front of the front end in which the accommodation groove 111 is formed is 21 to 22 mm and an angle formed by a lateral width of the accommodation groove 111 is 55.72°. According to the accommodation groove 111 configured as described above, the safety cover 110 is enabled to come into comfortable contact with the eyelid and a region therearound of the person to be treated with the eye being closed with a uniform pressure. Here, although it may be seen that the protruding levels of the eyeballs and the lateral widths of the eye sockets of Asians and Westerners are almost the same, the longitudinal lengths of the eye sockets have significant differences. Accordingly, in consideration of the above, it is preferable to provide respective shields with numerical values for Asians and Westerners and selectively use one of the shields.

In the safety cover 110, behind the accommodation groove 111, there is provided a working space 112 having a rearward-opening inlet to perform an extension operation and a finishing operation while accommodating the eyelashes clasped between the front end of the upper body 110a and the front end of the lower body 110b and protruding rearward. Here, the safety cover 110 is formed to have a shape in which a longitudinal length and a lateral width gradually increase from the front end toward a rear end such that the working space 112 is formed to gradually increase toward the inlet. When the working space 112 is formed to increase toward the inlet, as shown in a photo of FIG. 13, an eyelash extension operation may be safely and conveniently performed in the working space 112. The safety cover 110 includes polycarbonate (PC) which is a transparent material such that all operations performed in the working space 112 may be easily observed with the naked eye.

To allow the safety cover 110 to be divided into the upper body 110a and the lower body 110b such that the front ends thereof form one pair to be opened or closed, an upper extending portion 113a and a lower extending portion 113b which extend rearward are formed on left and right lower sides of the rear end of the upper body 110a and left and right lower sides of the rear end of the lower body 110b. Also, the upper extending portion 113a and the lower extending portion 113b are pivotably hinge-coupled with support portions 121 provided on left and right sides of the support frame 120 using hinge shafts 114a and 114b. The upper extending portion 113a and the lower extending portion 113b may include a matching protrusion 117a and a matching groove 117b for matching as shown in FIG. 9.

Meanwhile, a division line which divides the body into the upper body 110a and the lower body 110b traverses the front of the front end, which forms the accommodation groove 111 of the safety cover 110 in a vertically divided shape and continues to an end of a side surface of the safety cover 110.

In the safety cover 110, an upper lever 115a and a lower lever 115b, which have protrusion shapes respectively extending upward and downward, are provided on a top of the rear end of the upper body 110a and a bottom of the rear end of the lower body 110b. Hereby, as shown in FIG. 11, when a practitioner pushes the upper lever 115a and the lower lever 115b from above and below with a certain pressure or higher using his or her fingers, the front end of the upper body 110a and the front end of the lower body 110b, which usually face each other and are closed, are displaced above and below and opened to introduce the eyelashes of the person to be treated. When an external force is removed in this state, the front end of the upper body 110a and the front end of the lower body 110b clasp the eyelashes as is.

The support frame 120 is installed in a position spaced rearward apart from the safety cover 110 and is formed to have a quadrangular ring shape along a perimeter part of the inlet of the working space 112 of the safety cover 110. Also, as described above, the support portions 121 are formed on the left and right sides of the support frame 120 and extend forward with hinge shafts 114a and 114b on the left and right lower sides of the rear end of the upper body 110a and the left and right lower sides of the rear end of the lower body 110b being pivotable.

The springs 130a and 130b may be formed as coil-shaped compression springs 130a and 130b as shown in FIGS. 10 and 11. The springs 130a and 130b are installed forward on spring support portions 122 formed at a center of an upper end and a center of a lower end of the support frame 120 while the rear ends thereof are restrained by restraining pins 123 and push a center of an upper end of the upper body 110a and a center of a lower end of the lower body 110b of the safety body 110 forward. The front ends of the springs 130a and 130b are inserted into and mounted on an upper mount groove 116a and a lower mount groove 116b formed on the rear end of the upper body 110a and the rear end of the lower body 110b of the safety cover 110, respectively. The front end of the upper body 110a and the front end of the lower body 110b are induced by the springs 130a and 130b configured as described above to have a tendency to be continuously closed unless a certain or higher external force is applied through the upper lever 115a and the lower lever 115b.

Immediately after the eyelash strands 310 and the eyelashes of the person to be treated temporarily adhere to each other while being partially overlapped with each other with the bonding member 330 of the artificial eyelashes 300 for extension therebetween, the above-described shield 100 for eyelash extension clasps a region in which the root portions 310a of the eyelash strands 310 and the eyelashes of the person to be treated are overlapped with each other at the same time and is attached to an eyelid. Here, it is necessary to clasp the region such that the bonding member 330 is completely located in the working space 112 of the shield 100. When the shield 100 is precisely attached to the eyelid of the person to be treated, the artificial eyelashes 300 for extension and the eyelashes of the person to be treated are bonded to each other by heating and melting the bonding member 330 using the grips 210 of the thermal bonding device 200. Here, since the shield 100 attached to the eyelid of the person to be treated safely protects the eyeball from the grips 210 at a high temperature and clasps the eyelashes and the artificial eyelashes 300 for extension with a width adequate for completely accommodating a lateral width of the eye socket of the person to be treated, it is unnecessary to add and heat the artificial eyelashes 300 piece by piece and it is possible to perform a thermal bonding operation at once.

Subsequently, while the shield 100 is bonded to the eyelid of the person to be treated, a finishing operation of removing residual adhesives using simple tools and trimming the extended eyelashes may be performed.

As shown in FIGS. 5 and 6, the thermal bonding device 200 includes the pair of grips 210 at a front end thereof, which are configured to grip the eyelashes and to transfer high-temperature heat. A main body of the thermal bonding device 200 is used as a handle. In the main body, a motor and a gear assembly, which are configured to operate the grips 210, and a heater and the like configured to generate and transfer high-temperature heat to the grips 210 are installed. The thermal bonding device 200 may be automatically controlled to automatically perform a series of operations of opening and closing the grips 210 to grip and heat the eyelashes for a certain time and then opening the grips 210 again only when a switch installed on the main body is pressed once.

According to the embodiments of the present invention, when eyelash extension procedure is performed using artificial eyelashes for extension including a bonding member melted with viscosity when heat at a certain temperature or higher is applied and configured to bond eyelash strands to eyelashes of a person to be treated, working efficiency can be significantly improved and high-quality treatment can be performed by omitting a complicated process of applying an adhesive to the eyelashes of the person to be treated and simply attaching the artificial eyelashes.

Due to the bonding member having elasticity, even when a shock or an instantaneous external force is applied, an aligned state of the eyelash strands can be stably maintained. The artificial eyelashes are optimized for an exclusive shield thereof such that it is possible to safely and conveniently performing the eyelash extension procedure.

Although exemplary embodiments of the present invention have been described above, a variety of changes, modifications, and equivalents of the present invention may be used. It is apparent that the embodiments of the present invention may be adequately modified and equally applied. Therefore, the above description is not intended to limit the scope of the present invention which is defined by the following claims.

What is claimed is:

1. Artificial eyelashes for extension, which are configured to be attached to eyelashes of a person to be treated to extend a length of the eyelashes, comprising:
a bonding member provided on a point spaced apart from a vicinity of root portions of eyelash strands, configured to be a solid member attached to the eyelash strands at room temperature, and melted with viscosity to bond the eyelash strands to the eyelashes of the person to be treated when heat at a certain temperature or higher is applied.

2. The artificial eyelashes of claim 1, wherein the bonding member is a linear member provided to be parallel, with a gap therebetween, to a base configured to connect the root portions of the eyelash strands.

3. The artificial eyelashes of claim 2, wherein the bonding member is attached to a front or a rear of the eyelash strands while protruding therefrom.

4. The artificial eyelashes of claim 3, wherein the bonding member is provided to have a length which exceeds a region in which the eyelash strands are arranged such that ends thereof protrude leftward and rightward.

5. The artificial eyelashes of claim 3, wherein the bonding member is configured to be melted at a temperature of 90° C. to 130° C.

6. The artificial eyelashes of claim 3, wherein the bonding member comprises ethylene-vinyl acetate (EVA) copolymer as a major material having the highest content.

7. The artificial eyelashes of claim 6, wherein a pigment for imparting color is further added, as an additive, to the bonding member.

8. The artificial eyelashes of claim 7, wherein vitamin A, vitamin C, vitamin E, and peptides are added to the bonding member to be absorbed into the eyelashes of the person to be treated when the bonding member is heated and melted.

9. The artificial eyelashes of claim 3, wherein, to correspond to an exclusive shield for the artificial eyelashes, which is divided into an upper body and a lower body so that front ends thereof form one pair and are opened or closed to clasp the eyelashes of the person to be treated while an extension operation of adding the artificial eyelashes to the eyelashes of the person to be treated to extend a length thereof and which comprises an accommodation groove having a concave curve to accommodate a protruding eyeball of the person to be treated with an eye being closed in a front of the front end while facing the eyeball and being in contact with an eyelid of the person to be treated and comprises a safety cover behind the accommodation groove and having a working space with a rearward-opening inlet to accommodate the eyelashes of the person to be treated which are clasped between the front end of the upper body and the front end of the lower body and protrude, the bonding member is spaced at a distance of 1.0 to 5.0 mm apart from the root portions of the eyelash strands to be located in the working space provided in the safety cover of the shield when the front end of the upper body and the front end of the lower body of the shield clasp the eyelashes of the person to be treated and the root portions of the eyelash strands together.

10. The artificial eyelashes of claim 9, wherein the accommodation groove of the shield is formed to have a depth of 13.15 to 15.36 mm, a lateral width of 32.44 to 36.05 mm, and a longitudinal length 32.59 to 36.21 mm, and the bonding member is formed to have a lateral width less than the lateral width of the accommodation groove so as to be accommodated in the working space of the safety cover through the accommodation groove of the shield.

11. The artificial eyelashes of claim 9, wherein the front of the front end where the accommodation groove of the shield is formed has a curvature radius of 21 to 22 mm, and the bonding member is formed as a curve corresponding to the curvature radius of the accommodation groove of the shield.
